(19) United States
(12) Patent Application Publication
(10) Pub. No.: US 2013/0058448 A1
(43) Pub. Date: Mar. 7, 2013

(54) VIBRO-ACOUSTIC SENSORS FOR MATERIALS CHARACTERIZATION AND RELATED METHODS AND SYSTEMS

(71) Applicants: James A. Smith, Idaho Falls, ID (US); Dennis C. Kunerth, Idaho Falls, ID (US)

(72) Inventors: James A. Smith, Idaho Falls, ID (US); Dennis C. Kunerth, Idaho Falls, ID (US)

(73) Assignee: BATTELLE ENERGY ALLIANCE, LLC, Idaho Falls, ID (US)

(21) Appl. No.: 13/226,280

(22) Filed: Sep. 6, 2011

(51) Int. Cl. G21C 17/00

(52) U.S. Cl. 376/245

(57) ABSTRACT

A method for monitoring components in a nuclear reactor is provided along with related systems and component. In one embodiment, a system is provided that includes a first transducer mechanism disposed within a nuclear reactor, the first transducer being configured to emit a first wireless signal to an identified component of the nuclear reactor. A second transducer mechanism is configured to detect a response signal that is emitted by the identified component in response to the first wireless signal. In one particular embodiment, the first transducer mechanism may include one or more confocal transducers. The confocal transducer may include two or more electrodes configured to emit their respective beams coaxially with focal points that are coincidental. The system may be configured to determine a characteristic of a component being monitored. In one particular embodiment, the component may include a fuel rod.

### GOVERNMENT RIGHTS

This invention was made with government support under Contract Number DE-AC07-05ID14517 awarded by the United States Department of Energy. The government has certain rights in the invention.

### TECHNICAL FIELD

The present invention relates generally to sensors, sensor systems and related methods. In certain embodiments, sensors and associated components may be incorporated into, or used in association with, nuclear reactors and related systems. In other embodiments, the sensors and sensor systems may be utilized with other equipment and systems. In one particular example, sensors and sensor systems may be configured to provide, for example, leadless or wireless measurements of or more parameters or material characteristics associated with the operation of a nuclear reactor.

### BACKGROUND

Nuclear power is an important component of the world's energy resources. Research and development efforts are continually being made to try and find ways to improve the safety and efficiency of nuclear power reactors and plants. For example, different types and variations of fuels are being investigated and studied. Additionally, different types of materials for use in nuclear reactors are contemplated in an effort to improve the strength and integrity of such reactors and reactor components.

One of the difficulties in developing new technologies for use with nuclear reactors is determining the response of new materials or components when they are irradiated, or subjected to nuclear radiation. Various facilities have been established to help conduct experiments relating to the response of components and materials to irradiation. For example the Idaho National Laboratory operates a nuclear reactor known as the Advanced Testing Reactor (ATR) which enables irradiation experiments to take place at an accelerated rate of irradiation. In other words, the ATR facility provides an environment where the intensity of radiation can be tailored for a given experiment. Thus, the amount of radiation a given experiment sample might normally experience when exposed to the irradiation level present in a conventional nuclear reactor over a period of years can be replicated over a period of weeks or months using the ATR facility. The ability to provide an environment for these types of experiments is critical to the advancement of nuclear technologies. While the ATR facility is used as an example, there are other facilities throughout the world that similarly provide abilities to design and carry-out experiments at tailored rates of irradiation.

Often, it is desirable to obtain data associated with the response of a component or a material used in an irradiation experiment in real time (i.e., while the component or material is experiencing irradiation), or as close to real time as possible. However, such real-time data gathering in a nuclear environment can be challenging to say the least. Similarly, it is desirable to obtain real-time data regarding material and structural characteristics of components in an operational nuclear facility.

It is desirable to further improve the operation of nuclear reactors, the components used in nuclear reactors and the systems and components subjected to irradiation in nuclear facilities.

### BRIEF SUMMARY OF THE INVENTION

In accordance with the present invention, various embodiments of a monitoring system, as well as related methods and components, are set forth herein. In accordance with one embodiment of the present invention, a monitoring system is provided that includes a first transducer mechanism disposed within a nuclear reactor, the first transducer being configured to emit a first wireless signal to an identified component of the nuclear reactor. A second transducer mechanism is configured to detect a response signal that is emitted by the identified component in response to the first wireless signal.

In one particular embodiment, the first transducer mechanism may include one or more confocal transducers. The confocal transducer may be configured with a first electrode, surrounded by a second electrode, wherein the first electrode emits a beam at a first frequency and the second electrode emits a beam at a second frequency. The electrodes may be configured to emit their respective beams coaxially with focal points that are coincidental. In another embodiment, the first transducer mechanism may include a phased array configured to emit a focused beam on or in a desired structure to be inspected.

In one embodiment, the component being monitored or inspected may include a fuel rod having a volume of nuclear fuel disposed within a cladding material. The emitted signal may be focused on a surface or a portion of the fuel rod (or other component) to determine a characteristic thereof. For example, the emitted signal may be directed to the cladding material to determine if any cracks or other material anomalies are present. In another example, the emitted signal may be directed to an interface between the cladding material and a volume of fuel to monitor and characterize such an interface while the materials were being irradiated.

In one embodiment, the second transducer mechanism may include a sensor positioned within the nuclear reactor. For example, it may include one or more hydrophones positioned within a volume of coolant within the reactor. The hydrophones may detect the response signal as it is transmitted through the fluid medium of the coolant. In another embodiment, the second transducer mechanism may include a stethoscope like sensor that is positioned outside the reactor, such as adjacent the reactor shell, to detect the response signal.

In accordance with another embodiment of the present invention, a method of monitoring a component of a nuclear reactor is provided. The method includes inducing a wireless signal (e.g., an acoustic, optical or microwave signal) onto or into the component to be monitored, detecting a response signal generated by the component in response to the induced signal, and determining at least one characteristic of the component from the detected response signal.

In one particular embodiment, the act of inducing a wireless signal into the component may further include providing a first beam at a first frequency, providing a second beam at a second frequency, and causing the first beam and the second beam to have coinciding focal points at a location associated with the component. In another embodiment, the act of inducing a wireless signal into the component may include providing a signal from a phase array.

In one embodiment, the act of detecting a response signal generated by the component in response to the induced signal may further include wirelessly transmitting the response signal through the nuclear reactor. Further, the act of detecting a response signal generated by the component in response to the induced signal may include detecting the response signal with a sensor disposed within the reactor. For example, such an act may include detecting the response signal with a hydrophone disposed in a volume of coolant. In another embodiment, the act detecting a response signal generated by the component in response to the induced acoustic signal may further include detecting the response signal with a sensor disposed adjacent a shell of the reactor.

In one embodiment determining at least one characteristic of the component from the detected response signal may further include determining a characteristic of a fuel rod. For example, the method may include determining a characteristic of a cladding material of a fuel rod, a characteristic of a volume of nuclear fuel material, or it may provide information regarding the interaction of a volume of nuclear fuel with a cladding material such as at an interface of such materials.

In accordance with a further embodiment of the present invention, a method is provided for imaging a component. The method includes providing a component formed of a porous, heterogenous material. The component is subjected to a vibro-acoustic signal. An emitted signal, responsive to the component's exposure to the vibro-acoustic signal, is detected and flaws in the component that are larger than pores of the material are detected, based on the emitted signal.

In one embodiment, the component may be formed of nuclear grade graphite. In another embodiment, the component may include pores that are approximately 50 microns to approximately 900 microns in size. In another embodiment, the detection of flaws may include detecting flaws approximately 1 millimeter or greater in size. In yet another embodiment, the detection of flaws also includes determining a depth of the flaw within the component. In accordance with one embodiment, the method may further include positioning the component within a nuclear reactor and subjecting the component to the vibro-acoustic signal while the nuclear reactor is operational.

These and other aspects and features of the present invention will be ascertained in further examination of the description and drawings set forth herein.

### BRIEF DESCRIPTION OF THE SEVERAL VIEWS OF THE DRAWINGS

The foregoing and other advantages of the invention will become apparent upon reading the following detailed description and upon reference to the drawings in which:

FIG. 1 is a flow diagram depicting a method according to one aspect of the present invention;

FIGS. 2A and 2B are cross-sectional views of a fuel rod;

FIG. 3 is a schematic of a monitoring system in accordance of various aspects of the present invention; and

FIGS. 4A and 4B show a side view and a front view of a confocal transducer in accordance with one aspect of the present invention.

### DETAILED DESCRIPTION OF THE INVENTION

As discussed above, a number of facilities, such as the ATR facility (a National Scientific User Facility operated by the Idaho National Laboratory), are configured to conduct various irradiation experiments. The ATR is designed to enable simulation of long neutron radiation exposures in a short period of time, with a maximum power rating of 250 MWₜₕ and a maximum unperturbed thermal neutron flux of 1.0×10¹⁵ n/cm²-s. The ATR is cooled by pressurized water (approximately 2.5 MPa) that enters the reactor vessel bottom at an average temperature of approximately 52° C., flows up outside cylindrical tanks that supports and contain the core, passes through concentric thermal shields into the one upper part of the vessel, then flows down through the core to a flow distribution tank below the core. When the reactor is operating at full power, the primary coolant exits the vessel at a temperature of approximately 71° C.

The ATR has a unique design which enables large power variations among its various flux traps using a combination of various control cylinders and neck shim rods. For example, the control cylinders include hafnium plates that can be rotated toward and away from the core, while the shim rods may also contain hafnium and can be vertically inserted or withdrawn for minor power adjustments. A more detailed description of the ATR is set forth in the document entitled “FY 2009 Advanced Test Reactor National Scientific User Facility User's Guide” (a copy of which is located at https://secure.inl.gov/atrproposal/documents/ATRUsersGuide.pdf at the time the filing of this application), the contents of which are incorporated by reference herein in their entirety.

As noted in the aforementioned ATR “User's Guide,” the ATR also includes a hydraulic shuttle irradiation system (HSIS), sometimes referred to as a “rabbit,” which enables insertion and removal of experiment specimens during ATR operational cycles. This system provides increased flexibility in designing and carrying out irradiation experiments that are conducted in the ATR. Further details regarding the HSIS may be found in the document entitled “Hydraulic Shuttle Irradiation System (HSIS) Recently Installed in the Advanced Test Reactor (ATR)” (a copy of which is located at http://www.inl.gov/technicalpublications/Documents/4559415.pdf at the time of the filing of this application), the contents of which are incorporated by reference herein in their entirety.

The ATR, and similar facilities, are used to help advance the understanding of nuclear energy and its potential place in the future by, for example, expanding the fundamental understanding of nuclear fuel and materials behavior under irradiation. In order to further the understanding of irradiated fuels and materials during irradiation, more effective in-situ sensors and measurement systems are required to help analyze the various materials and components under irradiation. Robust and accurate in-pile measurements are instrumental to developing and validating a computationally-predictive multi-scale understanding of nuclear fuel and materials. Such sensing technologies may enable a more detailed understanding of the complex microstructure evolution of materials and fuels in a harsh irradiation environment. The increased availability and accuracy of in-pile measurement data will significantly advance fuel science, component and material modeling, fuel and material design. Such data will also help to reduce reactor variability during operation and, further, will enable the development of novel predictive control schemes.

Currently the ATR and other similar facilities utilize instrumented leads to make in-pile process measurements. Although instrumented leads can be an effective means to communicate data from within the reactor to the outside world, instrumented leads can also adversely change the measurement environment and they can be cumbersome to work with. Because the leads are difficult to design and cumbersome to install in the reactor, an instrumented lead experiment is expensive and requires long design and build times.

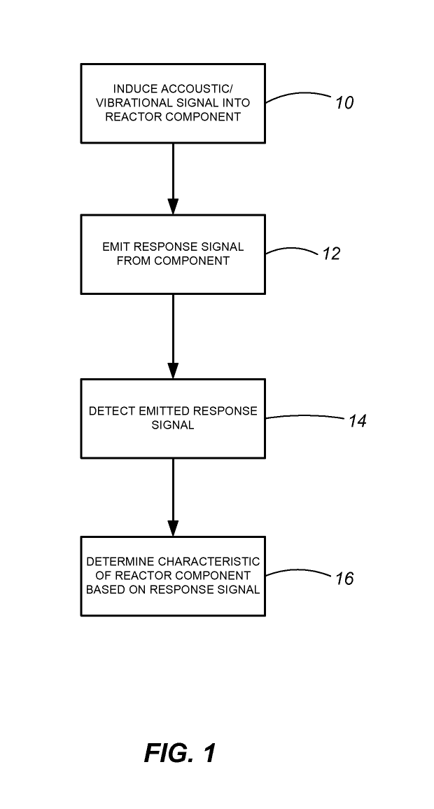

Referring to FIG. 1, a basic flow chart is shown with regard to a method of monitoring or inspecting a component of a nuclear reactor. Initially, one or more acoustic or vibrational signals are induced into a specified reactor component, as indicated at 10. The reactor component may be an operational component of the reactor (i.e., a component normally associated with the operation of the reactor), or it may include a test sample placed, for example, in a flux trap of the reactor for experimental or research purposes.

A response signal is emitted from the reactor component under observation, as indicated at 12, and the response signal is detected by a sensor, as indicated at 14, that may be placed in or adjacent to the reactor. In one embodiment, as discussed in further detail below, the response signal may be detected by placing a hydrophone in the coolant of the reactor and detecting a wireless signal that is propagated from the reactor component under observation through the coolant medium. After detection and receipt of the response signal, a characteristic of the component under observation may be determined, such as by analyzing the detected signal, as indicated 16.

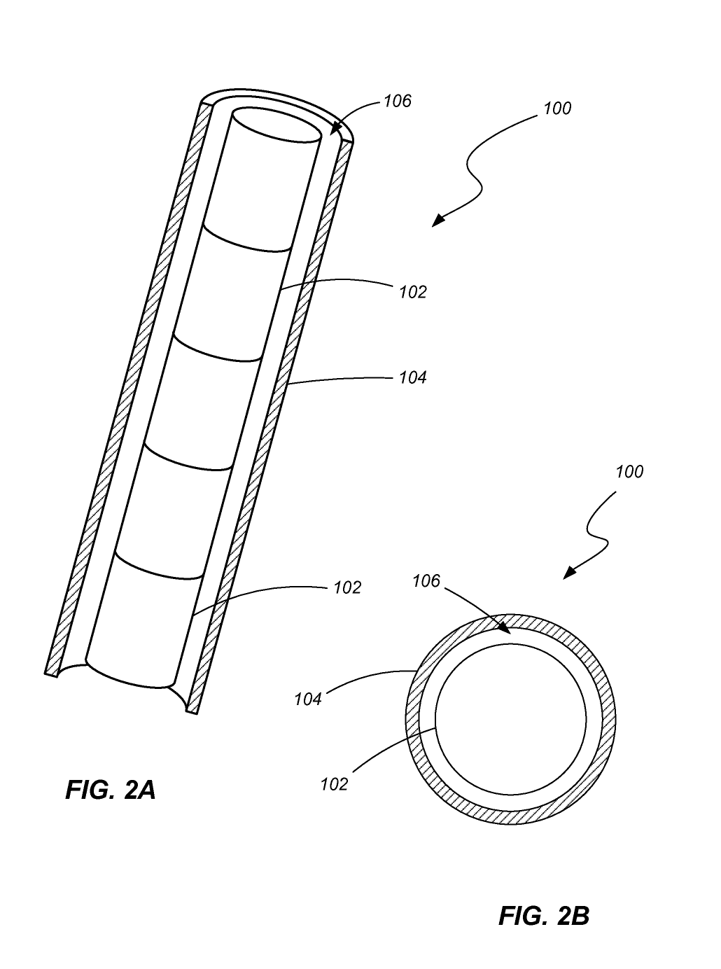

Considering one particular example that shows the need to obtain real-time data regarding the effects of irradiation, one cause of fuel failure in a nuclear reactor is the deleterious interaction between the fuel and the cladding of a fuel rod. For example, referring to FIGS. 2A and 2B, cross-sectional views are shown of an example of a fuel rod 100. The fuel rod 100 includes fuel in the form of pellets 102. The pellets 102 may be formed of a nuclear fuel comprising, for example, uranium, although other materials may be utilized as will be appreciated by those of ordinary skill in the art. Several pellets 102 may be stacked inside a tube which is commonly referred to as the cladding 104. The cladding 104 may be formed of a corrosion resistant material and serves as a barrier between the pellets 102 and coolant material that flows around the fuel rod 100 and transfers heat away from the fuel rod 100 during operation of a nuclear reactor. In one example, the cladding 104 may be formed of a corrosion resistant steel or metal alloy. However, other materials may be utilized. During operation of a nuclear reactor, several of the fuel rods 100 may be used together at the same time in a fuel bundle.

The fuel pellets 102 may be sized and configured so that (at least initially) there is a space 106, such as an annulus, between the exterior surface of the pellets 102 and the interior surface of the cladding 104. An inert gas, such as helium, may be disposed within the space 106 between the pellets 102 and cladding 104 to assist with heat transfer from the pellets 102 to the cladding 104. During irradiation, the pellets 102 heat up to high temperatures and expand to such an extend that they may eventually contact the cladding 104. Such interaction between the thermally expanded pellets 102 and the cladding 104 can produce significant thermal and mechanical stresses. For example, the pellets 102 may crack, resulting in increased electro-chemical potential interactions with the cladding 104. It is imperative to ensure that the thermal and mechanical stresses experienced by the cladding 104, along with any electro-chemical potential interactions experienced thereby, do not result in a failure or breach of the cladding 104. A breach or failure of the cladding 104 would ultimately result in the contamination of the coolant.

Detection of changes in the microstructure of the fuel pellets 102, the cladding 104, or both, is desirable to understand the effects of irradiation upon such materials, particularly when investigating new fuels and new cladding materials to ascertain their effectiveness in a nuclear environment. However, as will be appreciated by those of skill in the art, removing the fuel rods 100 from a nuclear reactor for regular inspection is not a realistic option. Further, inspection of a fuel rod that is still undergoing nuclear decay after removal from a reactor poses its own difficulties. Thus, other techniques need to be employed.

In accordance with one embodiment of the present invention, a wireless sensing technique, such as vibro-acoustic imaging, may be used to measure a characteristic of a material or component within a nuclear reactor. For example, such imaging may be used to image the cladding/fuel interface of a fuel rod, it may be used to detect cracks and voids within the cladding or at the surface of the fuel or it may be used to determine the speed of sound of material between two interfaces which is proportional to the material's elasticity. Such imaging, detection and analysis of components may be done in situ and in real time using a wireless signal. Obtaining such imaging and characterization data will further the development of nuclear technologies including, for example, interaction between the fuel and the cladding of a fuel rod.

The use of ultrasonic stimulated vibro-acoustics enables the collection of desired information through a noncontact wireless technique. While wires may still be used and penetrate the reactor vessel, for example to provide power to the ultrasonic transducer, the implementation of wireless data collection will greatly enhance the ability to monitor irradiation experiments in real time as well as provide enhanced monitoring capabilities of functioning nuclear reactors.

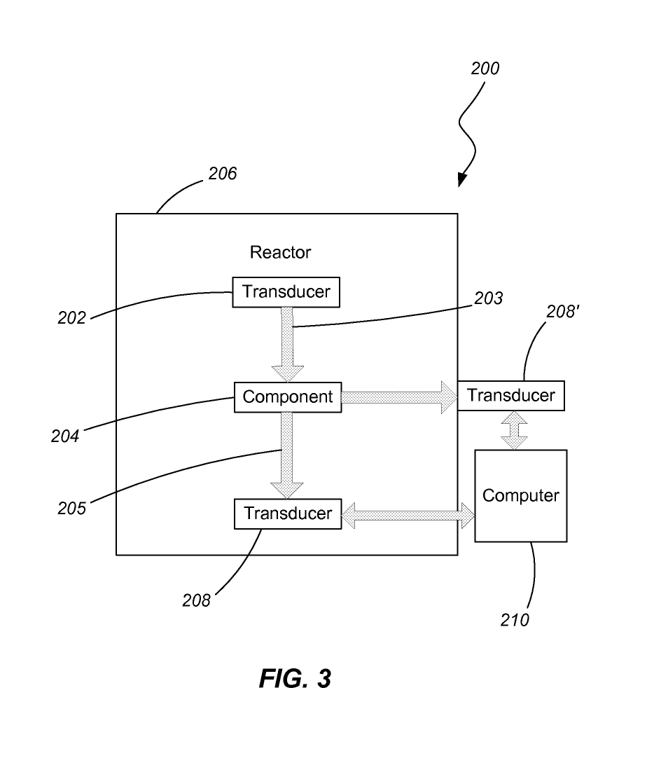

Referring to FIG. 3, a schematic is shown of a monitoring system 200 in accordance with one embodiment of the present invention. The system 200 includes a first transducer 202 or transducer mechanism that transmits a signal 203 to a component 204 that is to be monitored. In one example, the first transducer 202 may include a confocal transducer, as discussed in further detail below. However, other types of transducers or transducer mechanisms may be utilized. For example, a phase array may be utilized wherein multiple elements are pulsed with different time delays to generate a focused beam. Such a phase array may be used, for example, to scan a desired surface or interface that is to be monitored.

In certain embodiments, the signal 203 may include a vibrational signal or an acoustic signal. In other embodiments, the signal may include, for example, an optical signal, a radio frequency signal, a microwave signal or some other electromagnetic signal. For example, a microwave signal may be useful in inspecting or monitoring components that lack electrically conductive properties.

In the embodiment shown in FIG. 3, the first transducer 202 is positioned within a nuclear reactor 206 at a strategic location (e.g., at a specified distance from the component 204). In one embodiment, the first transducer 202 may include, for example, an ultrasonic transducer that is submerged in the coolant of the reactor 206 within a line-of-sight of the component 204 to be monitored or inspected. However, other types of transducers may be utilized. The component 204 being monitored may include, for example, a fuel rod such as has been described above.

A second transducer 208 may be positioned at a location relative to the reactor 206 to receive an acoustic or vibrational response signal 205 from the component 204. In other words, the signal 203 provided by the first transducer 202 is transmitted into the component 204 which then provides a response signal 205 that is detected by the second transducer 208. The second transducer 208 may be configured as a vibro-acoustic sensor, taking advantage of the components used in the construction of the reactor 206 in their communication of the response signal. In one embodiment, the response signal will include a single acoustical frequency that will be transmitted through the components of the reactor 206. In essence, the reactor 206 becomes filled with the acoustic response signal.

The transmission of the response signal throughout the reactor 206 enables the second transducer 208 to be located at a variety of locations and provides for substantial flexibility in designing such a monitoring system. For example, in one embodiment, the second transducer 208 may include a hydrophone disposed within the coolant of the reactor 206 to receive the response signal. The second transducer 208 may be wireless or leadless, providing additional flexibility to the monitoring system 200. Additionally, in one embodiment, the second transducer may be configured to be carried by a “rabbit” or HSIS associated with the reactor 206 such that the sensor may be introduced and removed from the reactor without interrupting an operational cycle, though a more likely use of the rabbit may include transporting samples to be tested or analyzed within the operational presence of the first transducer 202.

In another embodiment, the second transducer may include a vibro-acoustic sensor placed outside the reactor 206 (e.g., adjacent the reactor shell as indicated by transducer 208′) to receive the response signal. In yet another embodiment, multiple sensors may be utilized, including different types of sensors, or sensors positioned at a variety of locations relative to the component 204, to receive the response signal.

The response signal, or relevant data provided by the response signal, may then be analyzed to determine a desired characteristic of the component 204. The signal, or related data, may be stored in a device associated with the transducers (e.g., 208 or 208′), or it may be conveyed to another device, such as a computer 210 as indicated in FIG. 2. Such a computer 210 may include, for example, a central processing unit, data storage devices, memory, and input and output devices as will be appreciated by one of ordinary skill in the art. The computer 210 may further include software programs and a database having information that is relevant to the comparison and analysis of data being gathered from the transducers 208 and 208′.

Still considering the example of monitoring the effects of irradiation on a fuel rod, the response signal generated within the monitoring system 200 may provide information regarding the cracking of the fuel pellets or the cladding. Such information will enhance the understanding of different types of fuels and materials for future use in nuclear reactors.

Additionally, beyond its use in testing facilities, such as the ATR, such a monitoring system may be used in nuclear reactors that are operational for commercial or industrial purposes. For example, such a monitoring system 200 may be used to better determine the safe usable life of a fuel rod. In some instances, fuel rods are removed from reactors prior to the fuel being fully expended. This is sometimes done as a safety measure to ensure the integrity of the fuel rod and prevent any contamination of the coolant or other components of the reactor. A monitoring system such as described herein, or using various components and method acts as described herein, may be used to determine the integrity of fuel rods while they are in use so that the fuel may be more fully expended while still ensuring the mechanical integrity of the fuel rod cladding.

Another example application of the monitoring system may include the monitoring of components in a very high temperature reactor (VHTR). For example, a VHTR may include a graphite moderated core. In one embodiment, the graphite may be in the form of prism blocks, into which nuclear fuel rods are disposed. In another embodiment, nuclear fuel may be embedded in graphite pebbles. Adequate imaging and monitoring of nuclear grade graphite materials has been troublesome due, in part, to the porosity of such materials. However, it is believed that the use of the systems and methods such as described herein will provide accurate imaging and characterization of nuclear grade graphite and other similarly porous materials. More generally, the systems and methods described herein may be used to image, characterize and analyze porous, heterogenous materials.

Considering nuclear grade graphite, such material is a composite material made from petroleum or a coal tar based coke and a pitch binder. Manufacturing graphite is an iterative process of baking and pitch impregnation of a formed billet prior to final graphitization which occurs at temperatures greater than 2500° C. The impregnation and rebake step is repeated, often several times, until the desired product density is obtained. Manufacturing times for a lot of graphite can range from 6 to 9 months. In forming such graphite, isotropic cokes are used and an isotropic forming process (isostatically molded, vibrationally molded, or extruded) is employed with the intent to obtain an isotropic or near isotropic material. However, the source, size and blend of the starting materials as well as the forming process of the green billet will impart variations within the final product. As such, there will be density variations from the billet surface inward and different physical properties with, and transverse to, the forming direction. Thus, material variations are expected within individual billets as well as from billet-to-billet and from lot-to-lot. In addition to the material variations inherent to the manufacturing process, graphite will experience changes in volume, mechanical strength, and thermal properties while in service in a nuclear reactor. It is, therefore, desirable to characterize the graphite in its as-fabricated condition, as well as in its in-service condition in order to ensure that the graphite being used to construct a reactor meets engineering design requirements and that in-service integrity is maintained during operation of the reactor.

Due to the presence of porosity and its composite microstructure, graphite attenuates at relatively higher ultrasonic test frequencies. This combined with the range of acoustic velocities measured for next generation nuclear plant (NGNP) candidate graphite materials (C_{L}=2.5-2.9 kms⁻¹ and C_{S}=1.5-1.7 kms⁻¹, where C_{L} is the longitudinal velocity and C_{S} is the shear velocity) result in relatively long acoustic inspection wavelengths that limit the ability of ultrasonic inspections to detect small isolated flaws (e.g. 2.9 mm at 1 MHz). It is noted that since a large population of “flaws” or discontinuities already exist within the microstructure in the form of porosity, there is no practical need to detect small individual flaws or discontinuities less than, or equal in size to, the inherent pore size. For example, nuclear grade graphite materials may exhibit a porosity with pore sizes in the range of approximately 50 microns to approximately 900 microns, depending on the grade of graphite. Thus, knowing the porosity characteristics of a given material, the present methods may be used to detect flaws or discontinuities larger than such pore size for a given material component. Certainly, the methods and systems of the present invention may be used to determine flaws or discontinuities on the order of 1 millimeter or greater, with the ability to detect smaller sizes depending on the porosity of the graphite or other material.

Thus, despite the existence of pores in a material, it is still of value to be able to detect and characterize macro-cracks, large voids, inclusions and other discontinuities. Such flaws may arise from a variety of sources within a given component such as, for example, mechanical loading, irradiation, temperature, and other factors as will be appreciated by those of ordinary skill in the art. It will also be of value to be able to map changes in porosity from the surface inward due, for example, to oxidation. Due to the attenuation of high test frequencies and backscatter noise, conventional ultrasonic inspection approaches have limited spatial resolution and can only be used to detect substantially larger, isolated defects. Vibro-acoustic measurements can be used to detect these types of defects with improved spatial resolution and at smaller sizes.

In one example, acoustic velocity measurements can be used to characterize the uniformity of the microstructure of a component and detect the presence of distributed flaw structures internal to thick sections. In this case, the properties of the acoustic wave, (e.g. its velocity) is determined by the elastic properties of the test material as defined by the microstructure. Grain size, porosity, and distributed structures such as microcracking affect the elastic properties and therefore the acoustic velocity. While scatter type measurements, such as acousto-ultrasound, can also be used for making some types of measurement in which the character of the acoustic scatter is defined by the microstructure and the distributed flaw population, such approaches are integrated over a volume or path length and do not provide specific defect depth information. Vibro-acoustic measurements have the advantage of providing superior information including known depth of a given flaw.

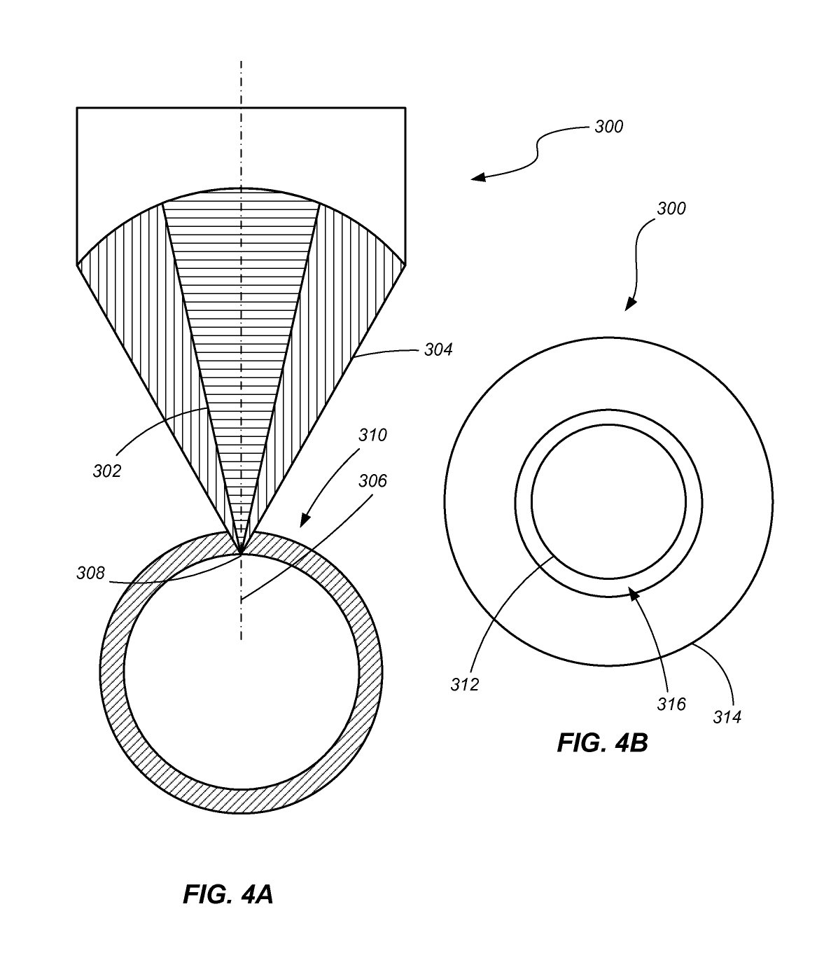

Referring now to FIGS. 4A and 4B in conjunction with FIG. 3, further details are shown with respect to the use of vibro-acoustography (VA) as an application of ultrasound imaging used in conjunction with a monitoring system 200 such as described above. VA is an imaging modality based on ultrasound-stimulated acoustic emission. VA uses the radiation force caused by the beating of two different frequencies to generate an acoustic emission signal. VA combines three mechanical responses of an object for forming the final image: absorption, acoustic impedance and acoustic emittance. Due to absorption or reflection, the energy density on the object at the acoustic focal point changes and produces an energy field called radiation force. High spatial resolution can be achieved since the radiation force can be highly localized to the focal point. Further details regarding the technique of VA, including components for use in such a technique, may be found in U.S. Pat. No. 5,991,239 entitled CONFOCAL ACOUSTIC FORCE GENERATOR, as well as in the document entitled “Vibro-acoustography: An imaging modality based on ultrasound-stimulated acoustic emission” by Fatemi and Greenleaf, published in Proceeding of the National Academy of Science, Vol. 96, pp 6603-6608, June 1999, the contents of both documents being hereby incorporated by reference herein in their entireties.

As seen in FIG. 4A, a confocal transducer 300 may be used to produce two continuous waves or beams 302 and 304 of slightly different frequencies. These two beams 302 and 304 have identical beam axes 306 and focal lengths, such that they intersect at a common focal point 308. In use, the focal point 308 is positioned on, or in, an object 310 to be monitored (e.g., a component 204 of a reactor 206). As shown in FIG. 4B, in one embodiment, the transducer 300 may include a first electrode 312 and a second electrode 314, separated by a gap 316, formed on a piezoelectric base. The first electrode 312 is driven at a first frequency (f₁) to generate the first beam 302 and the second electrode is driven at a second frequency (f₂) to generate the second beam 304.

The remote intersection and beating of the two waves 302 and 304 enables a distinction between transducer excitation energy and the object's acoustic emission signal. The acoustic emission from the interface (or the response signal described above) is detected by another transducer such as a hydrophone or other sensor (e.g., transducer 208 or 208′). In order to form a 2D image, a selected area may be covered by a raster scanning motion of the component by the confocal transducer 300 (or by an array of confocal transducers). It is noted that a phase array may also be used to form a 2D image by scanning an area of the component as has been discussed above.

It is important to note that an acoustic emission signal is only generated when the focal point of the transducer is at an interface between two mediums that have different acoustic impedances (e.g., such as at a surface of the cladding of a fuel rod as indicated in FIG. 4A). The impedance mismatch at such an interface causes a non-linearity and mixes the two frequencies of the two beams 302 and 304 to produce the beat frequency (acoustic emission or response signal) as they interfere at the focal point 308. If there is no such interface, the two frequencies pass through each other unimpeded at the focal point 308. There is no significant mixing of the two frequencies outside of the focal point since the curvatures of the acoustic wave fronts are different outside of the focal zone. In one embodiment, the frequencies f₁ and f₂ associated with the first and second beams 302 and 304 may generally be on order of MHz, while the difference in two frequencies (Δf), which is also the frequency of the acoustic emission or response signal, may be on order of approximately 10 to approximately 10,000 Hz and can be swept to perform resonant ultrasound spectroscopy. In another embodiment, such as when characterizing a graphite component, the frequencies f₁ and f₂ associated with the first and second beams 302 and 304 may be, for example, 100 kHz or greater. Likewise, in other embodiments, Δf may be at different frequencies including, for example, less than 10 Hz, or from approximately 50 to approximately 100 kHz. The frequencies, including the Δf, may be selected depending application. For example, the frequencies may be selected depending on the type of material that is being analyzed or monitored (e.g., graphite, metal, etc.), the material characteristic that is being evaluated (e.g., cracks, material interface, etc.), or both.

The previously incorporated article by Fatemi and Greenleaf (Vibro-acoustography: An imaging modality based on ultrasound-stimulated acoustic emission) provides an example of the capabilities of VA, disclosing that the imaging resolution of VA has been shown to be 700 μm for imaging a 380 μm diameter glass bead in water with the resulting images exhibiting high contrast with a high signal to noise ratio. Cyclic displacement of 100 nm at 10 kHz produces an acoustic intensity of approximately 3×10⁻³ watt/cm² in water. Hydrophones, for example, can detect intensities as low as 10⁻¹⁵ watt/cm². It has been estimated that one particular VA system was capable of measuring 6 nm vibrations from a 380 μm diameter glass bead in water. Accordingly, VA is capable of detecting low level displacements from a vibrating object such as a reactor component or a test sample placed within a reactor.

In using a confocal-transducer 300 such as described with respect to FIGS. 4A and 4B, the transducer 300 may be placed in the line-of-sight of a component, such as a fuel rod, to be tested or monitored. It is noted that other components may be utilized with a direct line of sight between the transducer 300 and the monitored component is not feasible or will be difficult to achieve. For example, an ultrasonic mirror may be used to turn and scan an ultrasonic beam, providing added flexibility in the resulting monitoring system.

The ultrasonic transducer 300 may be placed in a low nuclear flux location or it may be quickly moved into place only while scanning the component. When monitoring a fuel rod, as noted above, the diameter or cross-section area of a fuel pellet is typically less than the inside diameter or cross-sectional area of the cladding for a given fuel rod (at least initially). Thus, when the ultrasonic transducer is focused on the inner surface or interface of the cladding, a large acoustic signal will be reflected from the gap between the cladding and the fuel. As the fuel begins to expand and contact the cladding during operation of the nuclear reactor, the generated acoustic signal will drop in amplitude as the interface reflection coefficient begins to drop. Any surface cracks or voids on the order of 300 μm or greater will cause the interface reflection coefficient to increase which in turn will generate a larger acoustic signal. Diffusion and corrosion in the cladding will transform a sharply defined boundary into a blurred boundary. In this manner, cracks, voids, corrosion, and diffusion can be imaged along the fuel rod/cladding interface.

Of course other components may be monitored and different wireless imaging techniques may be utilized in obtaining real time data from a component within nuclear reactors. Thus, while the invention may be susceptible to various modifications and alternative forms, specific embodiments have been shown by way of example in the drawings and have been described in detail herein. However, it should be understood that the invention is not intended to be limited to the particular forms disclosed. Rather, the invention includes all modifications, equivalents, and alternatives falling within the spirit and scope of the invention as defined by the following appended claims.

What is claimed is:

1. A monitoring system, comprising:
a first transducer mechanism disposed within a nuclear reactor, the first transducer mechanism configured to emit a first wireless signal to an identified component of the nuclear reactor;
a second transducer mechanism configured to detect a response signal emitted by the identified component in response to the first wireless signal.

2. The system of claim 1, wherein the first transducer mechanism includes at least one confocal transducer configured to emit a first beam at a first frequency and at least a second beam at a second frequency.

3. The system of claim 2, wherein the at least one confocal transducer includes a first electrode configured to emit the first beam, and a second electrode configured to emit the at least a second beam, wherein the second electrode substantially surrounds the first electrode.

4. The system of claim 2, wherein the at least one confocal transducer is configured so that the first beam and the at least a second beam are coaxial and each exhibit a common focal point.

5. The system of claim 4, wherein the at least one confocal transducer is positioned and configured so that the common focal point coincides with a specific location associated with the identified component of the nuclear reactor.

6. The system of claim 5, wherein the identified component of the nuclear reactor includes a test sample disposed within the nuclear reactor.

7. The system of claim 5, wherein the identified component of the nuclear reactor includes a fuel rod having a volume of nuclear fuel and a cladding material.

8. The system of claim 7, wherein the at least one confocal transducer is positioned and configured so that the focal point coincides with at least one of a surface of the volume of nuclear fuel and the cladding material.

9. The system of claim 5, wherein the second transducer mechanism includes a sensor disposed within the nuclear reactor.

10. The system of claim 9, wherein the sensor includes a hydrophone disposed within a volume of coolant within the nuclear reactor.

11. The system of claim 5, wherein the second transducer mechanism includes a sensor positioned adjacent a shell of the reactor.

12. The system of claim 11, wherein the sensor is positioned at an exterior location relative to the shell of the reactor.

13. The system of claim 4, wherein the at least one confocal transducer is positioned within a volume of coolant within the nuclear reactor.

14. The system of claim 4, wherein the at least one confocal transducer includes an array of confocal transducers.

15. The system of claim 2, wherein the at least one transducer mechanism includes a phase array.

16. A method of monitoring a component of a nuclear reactor, the method comprising;
inducing an wireless signal into the component to be monitored;
detecting a response signal generated by the component in response to the induced wireless signal; and
determining at least one characteristic of the component from the detected response signal.

17. The method according to claim 16, wherein inducing a wireless signal into the component includes:
providing a first beam at a first frequency;
providing a second beam at a second frequency; and
causing the first beam and the second beam to have coinciding focal points at a location associated with the component.

18. The method according to claim 17, further comprising providing the component as a test specimen within the nuclear reactor.

19. The method according to claim 17, wherein detecting a response signal generated by the component in response to the induced wireless signal further includes wirelessly transmitting the response signal through the nuclear reactor.

20. The method according to claim 17, wherein detecting a response signal generated by the component in response to the induced wireless signal further includes detecting the response signal with a sensor disposed within the reactor.

21. The method according to claim 20, wherein detecting the response signal with a sensor disposed within the reactor further includes detecting the response signal with a hydrophone disposed in a volume of coolant.

22. The method according to claim 17, wherein detecting a response signal generated by the component in response to the induced wireless signal further includes detecting the response signal with a sensor disposed adjacent a shell of the reactor.

23. The method according to claim 22, wherein detecting the response signal with a sensor disposed adjacent a shell of the reactor includes positioning a sensor at a location exterior the shell of the reactor.

24. The method according to claim 16, wherein inducing a wireless signal into the component to be monitored includes inducing the signal into a fuel rod.

25. The method according to claim 24, wherein determining at least one characteristic of the component from the detected response signal further includes determining a characteristic of a cladding material of the fuel rod.

26. The method according to claim 24, wherein determining at least one characteristic of the component from the detected response signal further includes determining a characteristic of a volume of nuclear fuel of the fuel rod.

27. The method according to claim 24, wherein determining at least one characteristic of the component from the detected response signal further includes determining a characteristic of an interface between a volume of nuclear fuel and a cladding material of a fuel rod.

28. The method according to claim 16, wherein inducing a wireless signal into the component to be monitored includes raster scanning an area of the component with the wireless signal.

29. The method according to claim 16, wherein inducing a wireless signal into the component to be monitored includes inducing an acoustic signal into the component to be monitored.

30. The method according to claim 16, wherein inducing a wireless signal into the component to be monitored includes inducing at least one of an optical signal, a radio-frequency signal and a microwave signal into the component to be monitored.

31. The method according to claim 16, further comprising inducing the wireless signal into the component to be monitored using a phase array.

32. The method according to claim 16, wherein inducing an wireless signal into the component to be monitored includes inducing a signal into a nuclear grade graphite material.

33. A method of imaging a component, the method comprising:
providing a component formed of a porous, heterogenous material;
subjecting the component to a vibro-acoustic signal;
detecting a signal responsive to the component's exposure to the vibro-acoustic signal; and
detecting any flaws in the component that are larger than pores of the material based on the detected signal.

34. The method according to claim 33, wherein providing a component includes providing a component formed of nuclear grade graphite.

35. The method according to claim 33, wherein providing a component includes providing a component having a pores that are approximately 50 microns to approximately 900 microns in size.

36. The method according to claim 33, wherein detecting any flaws includes detecting any flaws approximately 1 millimeter or greater in size.

37. The method according to claim 33, wherein detecting any flaws also includes determining a depth of the flaw within the component.

38. The method according to claim 33, further comprising positioning the component within a nuclear reactor and wherein subjecting the component to a vibro-acoustic signal occurs while the nuclear reactor is operational.
